(19) United States
(12) Patent Application Publication
(10) Pub. No.: US 2024/0179690 A1
(43) Pub. Date: May 30, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/427,776

(22) Filed: Jan. 30, 2024

Related U.S. Application Data
(63) Continuation of application No. PCT/CN2022/108195, filed on Jul. 27, 2022.

(30) Foreign Application Priority Data
Aug. 2, 2021 (CN) 202110880786.0

(51) Int. Cl. H04W 72/0446; H04L 1/00; H04L 1/1607; H04W 72/11

(52) U.S. Cl. CPC H04W 72/0446; H04L 1/0003; H04L 1/1614; H04W 72/11

(57) ABSTRACT

The present application discloses a method and a device in a node for wireless communications. A first transceiver receives first information or transmits first information; and a first receiver receives a first signaling, and performs reception of a target downlink assignment in each time unit in a second time unit set; herein, the first signaling is used for activating a first SPS, and the target downlink assignment corresponding to each time unit in the second time unit set is a downlink assignment for the first SPS; the first signaling is used to determine at least one of a first time unit set or the second time unit set; the second time unit set is a proper subset of the first time unit set; the first information is used to determine which time units in the first time unit set belong to the second time unit set.

### CROSS REFERENCE TO RELATED APPLICATIONS

This application is the continuation of the international patent application No. PCT/CN2022/108195, filed on Jul. 27, 2022, and claims the priority benefit of Chinese Patent Application No. 202110880786.0, filed on Aug. 2, 2021, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

XR (i.e., Extended Reality) is considered to be a highly promising technology, and the optimal form and development trend for advancing the large-scale application of XR will become one of the typical applications of future communications; the support of XR services in 5G NR (New Radio) is an important aspect of system design. XR traffics are featured with quasi-periodic traffic model, high data rate and low-latency request; the configured assignment technique (for instance, Semi-persistent scheduling (SPS) or configured grant (CG)) in the existing technical specifications for the 3GPP NR is highly potential in matching with the three major features of XR traffics.

### SUMMARY

A typical incoming packet period for XR services is 1/30s, 1/60s, 1/120s, or other non-positive integer milliseconds; but the existing technical specification of 3GPP NR only supports a SPS period in positive integer milliseconds, which is not compatible with the incoming packet period of XR services. Thus, how to enhance the SPS to match the XR service period is a key issue that needs to be addressed.

To address the above problem, the present application provides a solution. It should be noted that although the description above only took XR traffics in 5G NR as an example, the present application is also applicable to other scenarios, such as other scenarios of 5G NR other than XR, 6G networks and V2X, where similar technical effects can be achieved. Additionally, the adoption of a unified solution for various scenarios, including but not limited to 5G NR or 6G networks or V2X, contributes to the reduction of hardcore complexity and costs, or an enhancement in performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving first information, or, transmitting first information; and
receiving a first signaling, and performing reception of a target downlink assignment in each time unit in a second time unit set;
herein, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one embodiment, a problem to be solved in the present application includes: how SPS matches the characteristic XR service period in non-positive integer milliseconds.

In one embodiment, characteristics of the above method include: unlike the equally spaced periodicity characteristic of conventional SPS, the second time unit set which is non-equally spaced determined from the first time unit set which is equally spaced is used for bearing a target downlink assignment for the first semi-persistent scheduling.

In one embodiment, advantages of the above method include: avoiding various influences brought about by the introduction of new lengths of period, particularly periods of non-positive integer milliseconds.

In one embodiment, advantages of the above method include: enhancing the flexibility of scheduling by the base station, which helps coordinate the SPS of XR services and the SPS of non-XR services.

In one embodiment, advantages of the above method include: helping reduce the consumption of Tx power of the UE.

In one embodiment, advantages of the above method include: helping ensure the delay requirement.

In one embodiment, advantages of the above method include: being applicable to different types of services, avoiding the tediousness of defining different lengths of period for different service types, with good forward compatibility guaranteed.

In one embodiment, advantages of the above method include: realizing the function of utilizing a limited form of SPS configuration to match the diverse periodicity of various services.

According to one aspect of the present application, the above method is characterized in that,
there are three time units in the second time unit set: the three time units are adjacent in the second time unit set, and, a time interval between start times of the first two time units among the three time units is unequal to a time interval between start times of the last two time units among the three time units.

In one embodiment, characteristics of the above method include: time units in the second time unit set are non-equally spaced apart.

According to one aspect of the present application, the above method is characterized in that,
the first information is used for configuring a first bitmap, the first bitmap comprising multiple bits, the first bitmap being used to determine the second time unit set from the first time unit set.

In one embodiment, characteristics of the above method include: matching of SPS and XR service periods is achieved based on a bitmap configured by the base station.

According to one aspect of the present application, the above method is characterized in that,
the first information is used for indicating a second time length, the second time length being different from the first time length; the second time length is used to determine at least a latter one of the first time length and the second time unit set.

In one embodiment, characteristics of the above method include: the first node determines a time-domain location of the downlink assignment of the SPS based on a time length (e.g., a time length corresponding to the XR service period) indicated by the base station or reported by the first node itself.

According to one aspect of the present application, the above method is characterized in that,
the first time length is equal to a positive integer in millisecond(s) (ms), while the second time length is equal to a non-positive integer in ms.

In one embodiment, characteristics of the above method include: matching the characteristic service period of non-positive integer milliseconds with multiple configured downlink assignments at intervals of positive integer milliseconds.

According to one aspect of the present application, the above method is characterized in that,
the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

According to one aspect of the present application, the above method is characterized in that,
a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

In one embodiment, characteristics of the above method include: determining an MCS or the quantity of transmission resources based on the delay of configured downlink assignments.

In one embodiment, advantages of the above method include: when a time unit in the second time unit set occurs at a time-domain location that has a larger delay compared with an instance of time of incoming packets of the services, reducing the MCS or increasing the transmission resources can reduce the retransmission probability to guarantee the delay requirement.

The present application provides a method in a second node for wireless communications, comprising:
transmitting first information, or, receiving first information; and
transmitting a first signaling, and performing transmission in a target downlink assignment corresponding to at least one time unit in a second time unit set;
herein, the first signaling is used for activating a first semi-persistent scheduling (SPS), each time unit in the second time unit set corresponds to a target downlink assignment, and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

According to one aspect of the present application, the above method is characterized in that,
there are three time units in the second time unit set: the three time units are adjacent in the second time unit set, and, a time interval between start times of the first two time units among the three time units is unequal to a time interval between start times of the last two time units among the three time units.

According to one aspect of the present application, the above method is characterized in that,
the first information is used for configuring a first bitmap, the first bitmap comprising multiple bits, the first bitmap being used to determine the second time unit set from the first time unit set.

According to one aspect of the present application, the above method is characterized in that,
the first information is used for indicating a second time length, the second time length being different from the first time length; the second time length is used to determine at least a latter one of the first time length and the second time unit set.

According to one aspect of the present application, the above method is characterized in that,
the first time length is equal to a positive integer in millisecond(s) (ms), while the second time length is equal to a non-positive integer in ms.

According to one aspect of the present application, the above method is characterized in that,
the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

According to one aspect of the present application, the above method is characterized in that,
a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

The present application provides a first node for wireless communications, comprising:
a first transceiver, receiving first information, or, transmitting first information; and
a first receiver, receiving a first signaling, and performing reception of a target downlink assignment in each time unit in a second time unit set;
herein, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

The present application provides a second node for wireless communications, comprising:
a second transceiver, transmitting first information, or, receiving first information; and
a second transmitter, transmitting a first signaling, and performing transmission in a target downlink assignment corresponding to at least one time unit in a second time unit set;
herein, the first signaling is used for activating a first semi-persistent scheduling (SPS), each time unit in the second time unit set corresponds to a target downlink assignment, and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one embodiment, the method in the present application has the following advantages:
avoiding the introduction of new lengths of period, particularly periods of non-positive integer milliseconds;
enhancing the flexibility of scheduling of the base station;
helping with coordination between SPSs used for different service types;
helping reduce the consumption of the UE's Rx power;
helping reduce the delay;
providing a uniformed framework of SPS applicable to all kinds of services;
being easily compatible.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram illustrating a second time unit set according to one embodiment of the present application.

FIG. 7 illustrates a schematic diagram of relations among first information, a first bitmap and a second time unit set according to one embodiment of the present application.

FIG. 8 illustrates a schematic diagram of relations among first information, a second time length, a first time length and a second time unit set according to one embodiment of the present application.

FIG. 9 illustrates a schematic diagram illustrating a second time length and a first time length according to one embodiment of the present application.

FIG. 10 illustrates a schematic diagram illustrating an index of a time unit in a first time unit set according to one embodiment of the present application.

FIG. 11 illustrates a schematic diagram of relation(s) between at least one of {a Modulation and Coding Scheme (MCS) used, a number of frequency-domain resources occupied, a number of time-domain resources occupied} by the target downlink assignment corresponding to a given time unit and a time-domain position of the given time unit according to one embodiment of the present application.

FIG. 12 illustrates a structure block diagram of a processing device in a first node according to one embodiment of the present application.

FIG. 13 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of processing of a first node according to one embodiment of the present application, as shown in FIG. 1.

In Embodiment 1, the first node in the present application receives first information or transmits first information in step 101; and receives a first signaling in step 102; and performs reception of a target downlink assignment in each time unit in a second time unit set in step 103.

In Embodiment 1, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one embodiment, the first node receives the first information.

In one embodiment, the first node transmits the first information.

In one embodiment, the first information is a higher layer signaling.

In one embodiment, the first information is an RRC signaling.

In one embodiment, the first information comprises one or more fields in an RRC signaling.

In one embodiment, the first information comprises one Information Element (IE).

In one embodiment, the first information comprises one or more fields in an IE.

In one embodiment, the first information is a MAC CE signaling.

In one embodiment, the first information comprises one or more fields in a MAC CE signaling.

In one embodiment, the first information comprises an IE SPS-Config.

In one embodiment, the first information comprises an IE ConfiguredGrantConfig.

In one embodiment, the first information is information indicated by an RRC signaling or a MAC CE signaling.

In one embodiment, the first information is information reported by UE.

In one embodiment, the first signaling is a physical layer signaling.

In one embodiment, the first signaling is a piece of Downlink control information (DCI).

In one embodiment, the first signaling comprises one or more fields in a DCI.

In one embodiment, the first signaling is a higher layer signaling.

In one embodiment, the first signaling is an RRC signaling.

In one embodiment, the first signaling comprises one or more fields in an RRC signaling.

In one embodiment, the first signaling comprises one Information Element (IE).

In one embodiment, the first signaling comprises one or more fields in an IE.

In one embodiment, the first signaling is a MAC CE signaling.

In one embodiment, the first signaling comprises one or more fields in a MAC CE signaling.

In one embodiment, the first signaling is a DownLink Grant Signaling.

In one embodiment, the first signaling is an UpLink Grant Signaling.

In one embodiment, the first signaling comprises an IE SPS-Config.

In one embodiment, the first signaling comprises an IE ConfiguredGrantConfig.

In one embodiment, the first signaling is a DCI format, Cyclic Redundancy Check (CRC) of the DCI format being scrambled by a CS-RNTI.

In one embodiment, the meaning of performing reception of a target downlink assignment includes: receiving a PDSCH corresponding to a target downlink assignment at the physical layer.

In one embodiment, the meaning of performing reception of a target downlink assignment includes: receiving at least one transport block (TB) in a PDSCH corresponding to a target downlink assignment at the physical layer.

In one embodiment, the first semi-persistent scheduling is a semi-persistent scheduling configured by an RRC signaling.

In one embodiment, the first semi-persistent scheduling is configured with at least one of periodicity, a number of HARQ processes or a HARQ process offset.

In one embodiment, the first semi-persistent scheduling is used to schedule multiple PDSCHs, each of the multiple PDSCHs being a PDSCH without a corresponding PDCCH transmission.

In one embodiment, the first semi-persistent scheduling is used to schedule multiple PDSCHs without corresponding PDCCH transmissions, the multiple PDSCHs without corresponding PDCCH transmissions respectively belonging to multiple time units in time domain, the multiple time units being non-equally spaced in time domain.

In one embodiment, each target downlink assignment respectively corresponds to a PDSCH scheduled by the first semi-persistent scheduling.

In one embodiment, a downlink assignment used for the first semi-persistent scheduling is a configured downlink assignment.

In one embodiment, the second time unit set consists of multiple time units sequentially arranged in time domain.

In one embodiment, the first signaling is used to determine the first time unit set.

In one embodiment, the first signaling is used to determine the second time unit set.

In one embodiment, the first signaling is used to determine a starting time unit in the first time unit set.

In one embodiment, the first signaling is used to determine a starting time unit in the second time unit set.

In one embodiment, the first signaling is used to indicate a starting time unit in the first time unit set.

In one embodiment, the first signaling is used to indicate a starting time unit in the second time unit set.

In one embodiment, the first signaling is used to explicitly indicate a starting time unit in the first time unit set.

In one embodiment, the first signaling is used to explicitly indicate a starting time unit in the second time unit set.

In one embodiment, the first signaling is used to implicitly indicate a starting time unit in the first time unit set.

In one embodiment, the first signaling is used to implicitly indicate a starting time unit in the second time unit set.

In one embodiment, a starting time unit in the first time unit set is: a time unit to which a PDSCH that initializes (or re-initializes) a configured downlink assignment belongs in time domain when the first signaling activates the first semi-persistent scheduling.

In one embodiment, a starting time unit in the second time unit set is: a time unit to which a PDSCH that initializes (or re-initializes) a configured downlink assignment belongs in time domain when the first signaling activates the first semi-persistent scheduling.

In one embodiment, a starting time unit in the first time unit set and a starting time unit in the second time unit set are a same time unit.

In one embodiment, a starting time unit in the first time unit set is before a starting time unit in the second time unit set.

In one embodiment, a starting time unit in a time unit set is an earliest time unit in the time unit set.

In one embodiment, the first signaling and the first time length are used together to determine the first time unit set.

In one embodiment, the time unit is a millisecond (ms).

In one embodiment, the time unit is a slot.

In one embodiment, the time unit is a sub-slot.

In one embodiment, a said time unit includes one or more symbols.

In one embodiment, the time unit is a symbol.

In one embodiment, the time unit is an Orthogonal Frequency Division Multiplexing (OFDM) Symbol.

In one embodiment, the time unit is a Single Carrier-Frequency Division Multiple Access (SC-FDMA) symbol.

In one embodiment, the time unit is a Discrete Fourier Transform Spread OFDM (DFT-S-OFDM) symbol.

In one embodiment, the time unit is a Filter Bank Multi Carrier (FBMC) symbol.

In one embodiment, the time unit comprises a Cyclic Prefix (CP).

In one embodiment, the first time length is default.

In one embodiment, the first time length is configurable.

In one embodiment, the first time length is a periodicity configured by higher layer signaling.

In one embodiment, the first time length is a periodicity configured by RRC signaling.

In one embodiment, the first time length is equal to a positive integer in milliseconds (ms).

In one embodiment, the first time length is a time length in a first candidate time length set, the first candidate time length set comprising multiple candidate time lengths.

In one embodiment, the first time length is a time length in a first candidate time length set, the first candidate time length set comprising at least 10 ms, 20 ms, 32 ms, 40 ms, 64 ms, 80 ms, 128 ms, 160 ms, 320 ms and 640 ms.

In one embodiment, the first candidate time length set is default or configurable.

In one embodiment, the first candidate time length set is configured by RRC signaling.

In one embodiment, the above method is characterized in that
the first node determines the first time length according to at least the first information.

In one embodiment, the first information is used to indicate the first time length.

In one embodiment, the first information is used to infer the first time length.

In one embodiment, the above method is characterized in comprising:
the first node also receiving second information; herein, the second information is used to indicate the first time length.

In one embodiment, the second information is an IE.

In one embodiment, the second information comprises at least one field in an IE.

In one embodiment, the second information is a periodicity field.

In one embodiment, the second information and the first information respectively comprise different fields in a same IE.

In one embodiment, the second information and the first information are respectively different IEs.

In one embodiment, the second information is a higher-layer signaling.

In one embodiment, the second information and the first information are used together to indicate the first time length.

In one embodiment, two time units in the first time unit set being adjacent means that there does exist any other time unit in the first time unit set between the two time units in the first time unit set.

In one embodiment, any two adjacent time units in the first time unit set are non-consecutive in time domain.

In one embodiment, the statement that a time interval between start times of any two adjacent time units in the first time unit set is equal to the first time length means that: the first time length is equal to K times a duration of a time unit, K being a positive integer, and a number of consecutive time units between any two adjacent time units in the first time unit set is equal to K−1.

In one embodiment, the statement that a time interval between start times of any two adjacent time units in the first time unit set is equal to the first time length means that: the first time length is equal to K times a duration of a time unit, K being a positive integer, and a difference of indexes of any two adjacent time units in the first time unit set is equal to a result yielded by K modulo a second value, the second value being 1024 times a number of consecutive slots per frame.

In one embodiment, an index of a time unit is an index determined by a System Frame Number (SFN) of a frame to which the time unit belongs and a slot number corresponding to the time unit together.

In one embodiment, an index of a time unit is an index determined by an SFN of a frame to which the time unit belongs, a slot number of a slot to which the time unit belongs and a symbol number corresponding to the time unit together.

In one embodiment, the time unit in the present application is slot; an index of a time unit is equal to a number of consecutive slots per frame multiplied by a System Frame Number (SFN) of a frame to which the time unit belongs plus a slot number corresponding to the time unit in a frame to which the time unit belongs.

In one embodiment, the time unit in the present application is symbol; the index of a time unit is equal to a System Frame Number (SFN) of a frame to which the time unit belongs multiplied by a number of consecutive slots per frame multiplied by a number of consecutive symbols per slot plus a slot number corresponding to the time unit in the frame to which the time unit belongs multiplied by the number of consecutive symbols per slot plus a symbol number corresponding to the time unit in a slot to which the time unit belongs.

In one embodiment, the second time unit set is not empty.

In one embodiment, the second time unit set comprises multiple time units.

In one embodiment, the first node drops performing reception of downlink assignment for the first semi-persistent scheduling in other time units in the first time unit set other than the second time unit set.

### Embodiment 2

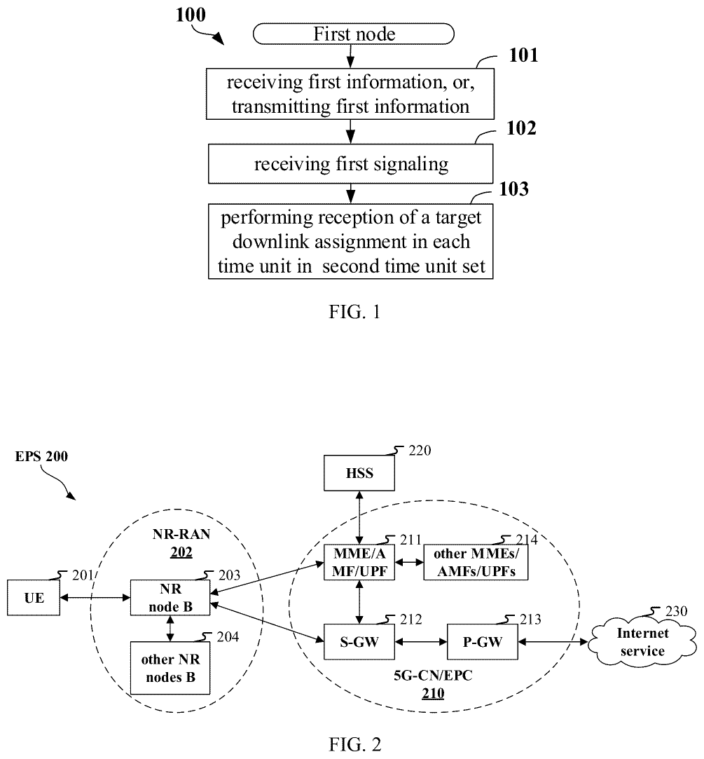

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called abase station, abase transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the second node in the present application.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MacroCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station supporting large time-delay difference.

In one embodiment, the gNB 203 is a flight platform.

In one embodiment, the gNB 203 is satellite equipment.

In one embodiment, the first node and the second node in the present application both correspond to the UE 201, for instance, V2X communications is performed between the first node and the second node.

### Embodiment 3

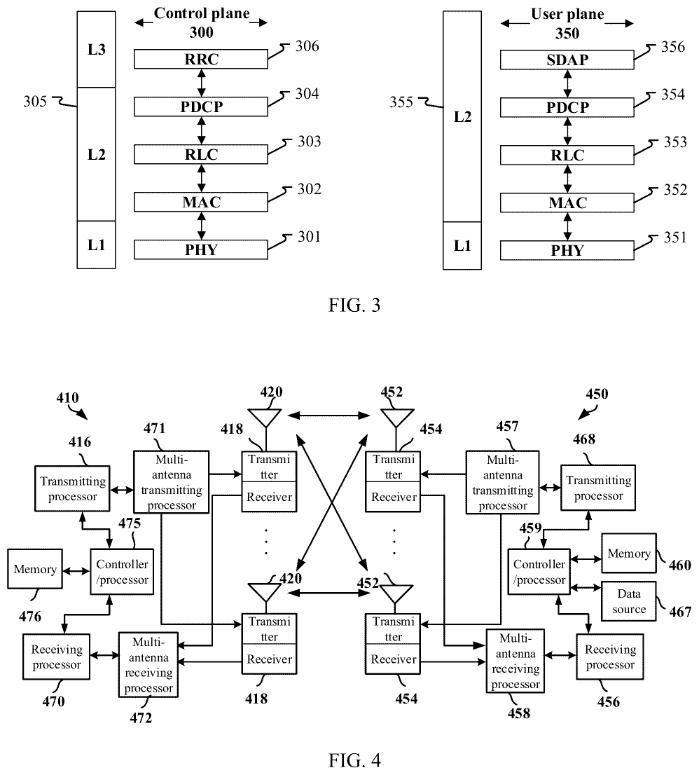

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are L1, L2 and L3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service DataAdaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, the first information in the present application is generated by the RRC sublayer 306.

In one embodiment, the first information in the present application is generated by the MAC sublayer 302.

In one embodiment, the first information in the present application is generated by the MAC sublayer 352.

In one embodiment, the first information in the present application is generated by the PHY 301.

In one embodiment, the first information in the present application is generated by the PHY 351.

In one embodiment, the second information in the present application is generated by the RRC sublayer 306.

In one embodiment, the second information in the present application is generated by the MAC sublayer 302.

In one embodiment, the second information in the present application is generated by the MAC sublayer 352.

In one embodiment, the second information in the present application is generated by the PHY 301.

In one embodiment, the second information in the present application is generated by the PHY 351.

### Embodiment 4

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also responsible for a retransmission of a lost packet, and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also in charge of a retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second node is a UE, and the first node is a base station.

In one subembodiment, the second node is a relay node, and the first node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives first information, or transmits first information; and receives a first signaling; and performs reception of a target downlink assignment in each time unit in a second time unit set; herein, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one subembodiment, the second communication device 450 corresponds to the first node in the present application.

In one embodiment, the second communication device 450 comprises a memory that stores computer readable instruction program, the computer readable instruction program generates actions when executed by at least one processor, which include: receiving first information, or transmitting first information; and receiving a first signaling; and performing reception of a target downlink assignment in each time unit in a second time unit set; herein, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one subembodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits first information, or receives first information; and transmits a first signaling; and performs transmission in a target downlink assignment corresponding to at least one time unit in a second time unit set; herein, the first signaling is used for activating a first semi-persistent scheduling (SPS), each time unit in the second time unit set corresponds to a target downlink assignment, and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one subembodiment, the first communication device 410 corresponds to the second node in the present application.

In one embodiment the first communication device 410 comprises a memory that stores computer readable instruction program, the computer readable instruction program generates actions when executed by at least one processor, which include: transmitting first information, or receiving first information; and transmitting a first signaling; and performing transmission in a target downlink assignment corresponding to at least one time unit in a second time unit set; herein, the first signaling is used for activating a first semi-persistent scheduling (SPS), each time unit in the second time unit set corresponds to a target downlink assignment, and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for receiving the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the receiver 454, the multi-antenna receiving processor 458, the receiving processor 456, the controller/processor 459, the memory 460, or the data source 467 is used for receiving the first information in the present application.

In one embodiment, at least one of the antenna 420, the transmitter 418, the multi-antenna transmitting processor 471, the transmitting processor 416, the controller/processor 475 or the memory 476 is used for transmitting the first information in the present application.

In one embodiment, at least one of the antenna 452, the transmitter 454, the multi-antenna transmitting processor 468, the controller/processor 459, the memory 460 or the data source 467 is used for transmitting the first information in the present application.

In one embodiment, at least one of the antenna 420, the receiver 418, the multi-antenna receiving processor 472, the receiving processor 470, the controller/processor 475, or the memory 476 is used for receiving the first information in the present application.

In one embodiment, at least one of the antenna 452, the receiver 454, the multi-antenna receiving processor 458, the receiving processor 456, the controller/processor 459, the memory 460, or the data source 467 is used for receiving the second information in the present application.

In one embodiment, at least one of the antenna 420, the transmitter 418, the multi-antenna transmitting processor 471, the transmitting processor 416, the controller/processor 475 or the memory 476 is used for transmitting the second information in the present application.

### Embodiment 5

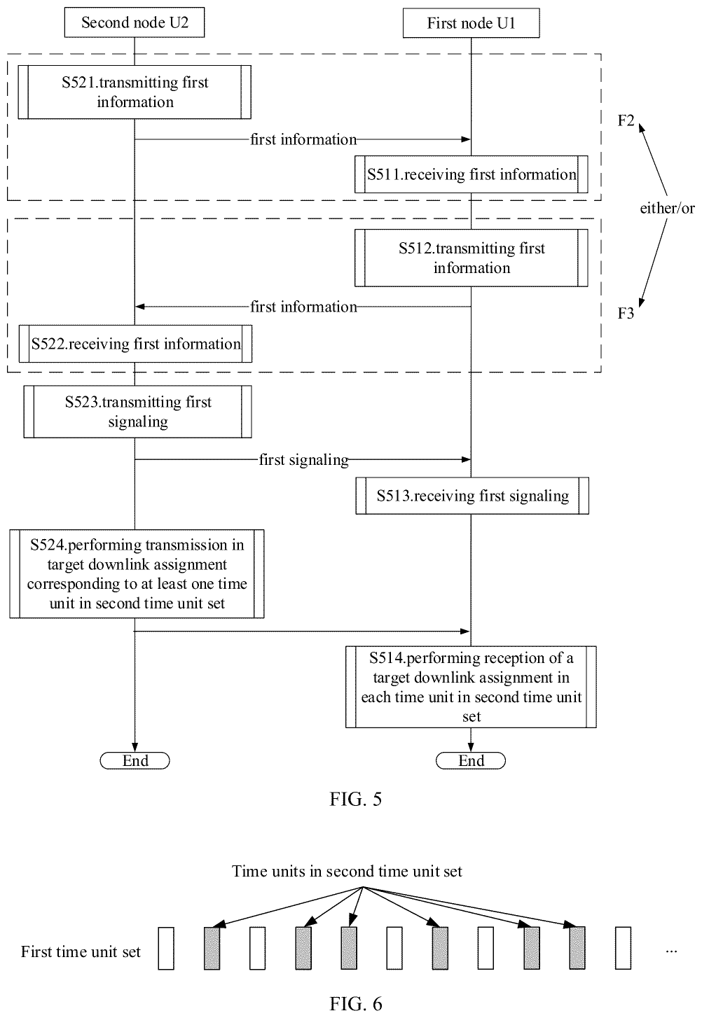

Embodiment 5 illustrates a flowchart of signal transmission according to one embodiment of the present application, as shown in FIG. 5. In FIG. 5, a first node U1 and a second node U2 are in communications via an air interface. In FIG. 5, steps exist in only one of the box F2 framed with dotted lines or the box F3 framed with dotted lines.

The first node U1 receives first information in step S511 or transmits first information in step S512; and receives a first signaling in step S513; and performs reception of a target downlink assignment in each time unit in a second time unit set in step S514.

The second node U2 transmits first information in step S521 or receives first information in step S522; and transmits a first signaling in step S523; and performs transmission in a target downlink assignment corresponding to at least one time unit in a second time unit set in step S524.

In Embodiment 5, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set; the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame; there are three time units in the second time unit set: the three time units are adjacent in the second time unit set, and, a time interval between start times of the first two time units among the three time units is unequal to a time interval between start times of the last two time units among the three time units.

In one subembodiment of Embodiment 5, the first information is used for configuring a first bitmap, the first bitmap comprising multiple bits, the first bitmap being used to determine the second time unit set from the first time unit set.

In one subembodiment of Embodiment 5, the first information is used for indicating a second time length, the second time length being different from the first time length; the second time length is used to determine at least a latter one of the first time length and the second time unit set; the first time length is equal to a positive integer in millisecond(s) (ms), while the second time length is equal to a non-positive integer in ms.

In one subembodiment of Embodiment 5, a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a U1 interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, an air interface between the second node U2 and the first node U1 includes a radio interface between a UE and another UE.

In one embodiment, a target downlink assignment corresponding to a time unit in the second time unit set is: a target downlink assignment that exists in the time unit in the second time unit set.

In one embodiment, time-domain resources occupied by a target downlink assignment corresponding to a time unit in the second time unit set belong to the time unit in the second time unit set.

In one embodiment, the second node U2 performs transmission in the target downlink assignment corresponding to each time unit in the second time unit set.

In one embodiment, the second node U2 does not perform transmission in the target downlink assignment corresponding to at least one time unit in the second time unit set.

In one embodiment, both the first time length and the second time length are positive integral multiples of 1 ms.

In one embodiment, steps marked by the dotted-line box F2 exist, while steps marked by the dotted-line box F3 do not exist.

In one embodiment, steps marked by the dotted-line box F2 do not exist, while steps marked by the dotted-line box F3 exist.

### Embodiment 6

Embodiment 6 illustrates a schematic diagram illustrating a second time unit set according to one embodiment of the present application, as shown in FIG. 6. In FIG. 6, each box (including those in blank or in grey) represents a time unit in a first time unit set, and each grey-filled box represents a time unit in a second time unit set; the sequential order of two boxes indicates a chronological order in which two corresponding time units are sorted.

In Embodiment 6, the first time unit set in the present application consists of multiple time units sequentially arranged in time domain; and the second time unit set in the present application is a proper subset of the first time unit set; there are three time units in the second time unit set: the three time units are adjacent in the second time unit set, and, a time interval between start times of the first two time units among the three time units is unequal to a time interval between start times of the last two time units among the three time units.

In one embodiment, the statement that the three time units are adjacent in the second time unit set means that: between an earliest time unit and a latest time unit among the three time units there does not exist any other time unit in the second time unit set other than the three time units.

In one embodiment, the statement that the three time units are adjacent in the second time unit set means that: between a start of an earliest time unit and an end of a latest time unit among the three time units there does not exist any other time unit in the second time unit set other than the three time units.

In one embodiment, there are three time units in the second time unit set: the three time units are adjacent in the second time unit set, and, a result yielded by a difference of indexes of the first two time units among the three time units modulo a second value is unequal to a result yielded by a difference of indexes of the last two time units among the three time units modulo the second value, the second value being 1024 times the number of consecutive slots per frame.

In one embodiment, there are three time units in the second time unit set: the three time units are adjacent in the second time unit set, and, a number of consecutive time units between the first two time units among the three time units is unequal to a number of consecutive time units between the last two time units among the three time units.

### Embodiment 7

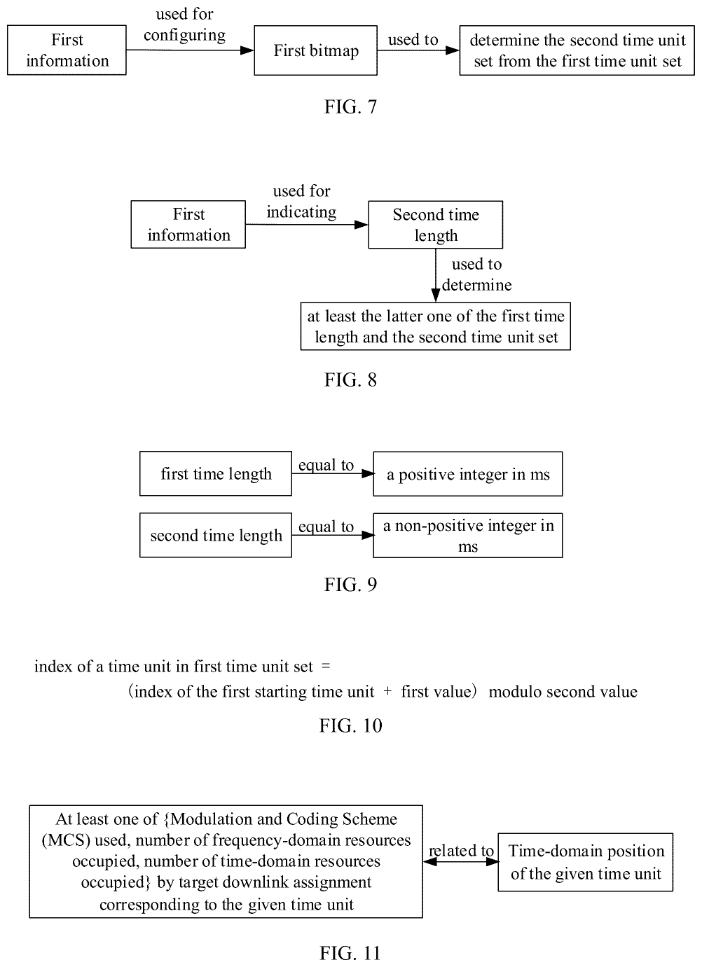

Embodiment 7 illustrates a schematic diagram of relations among first information, a first bitmap and a second time unit set according to one embodiment of the present application, as shown in FIG. 7.

In Embodiment 7, the first information in the present application is used for configuring the first bitmap in the present application, the first bitmap comprising multiple bits, the first bitmap being used to determine the second time unit set in the present application from the first time unit set in the present application.

In one embodiment, the first bitmap is used to indicate the second time unit set from the first time unit set.

In one embodiment, the first time unit set comprises multiple time unit subsets, each of the multiple time unit subsets comprising the same number of time units, the first bitmap being used to indicate time unit(s) belonging to the second time unit set from each one of the multiple time unit subsets.

In one embodiment, the first time unit set comprises multiple time unit subsets, each of the multiple time unit subsets comprising the same number of time units; multiple bits in the first bitmap respectively correspond to multiple time units comprised by each time unit subset among the multiple time unit subsets; when a value of one bit in the first bitmap is equal to 1, a time unit in the each time unit subset among the multiple time unit subsets that corresponds to the bit in the first bitmap belongs to the second time unit set; when the value of one bit in the first bitmap is equal to 0, a time unit in the each time unit subset among the multiple time unit subsets that corresponds to the bit in the first bitmap does not belong to the second time unit set.

In one embodiment, the first time unit set comprises multiple time unit subsets, each of the multiple time unit subsets comprising the same number of time units; multiple bits in the first bitmap respectively correspond to multiple time units comprised by each time unit subset among the multiple time unit subsets; when a value of one bit in the first bitmap is equal to 0, a time unit in the each time unit subset among the multiple time unit subsets that corresponds to the bit in the first bitmap belongs to the second time unit set; when the value of one bit in the first bitmap is equal to 1, a time unit in the each time unit subset among the multiple time unit subsets that corresponds to the bit in the first bitmap does not belong to the second time unit set.

In one embodiment, the first bitmap is a bitmap.

In one embodiment, the intersection of any two time unit subsets among the multiple time unit subsets is the empty set.

In one embodiment, an i-th time unit subset of the multiple time unit subsets comprises the ((i−1)×R+1)-th through the (i×R)-th time unit in the first time unit set; i being a positive integer, and R being equal to a number of bits included in the first bitmap, and i×R being no greater than a total number of time units in the first time unit set.

In one embodiment, an i-th time unit subset of the multiple time unit subsets comprises the ((i−1)×R+1+u)-th through the (i×R+u)-th time unit in the first time unit set; i and u being positive integers, where u is default or configurable, and R being equal to a number of bits included in the first bitmap, and i×R+u being no greater than a total number of time units in the first time unit set.

In one embodiment, the rule of correspondence between the multiple bits in the first bitmap and the multiple time units included in each time unit subset of the multiple time unit subsets is predefined.

In one embodiment, the rule of correspondence between the multiple bits in the first bitmap and the multiple time units included in each time unit subset of the multiple time unit subsets is configured by RRC signaling.

In one embodiment, the multiple bits in the first bitmap and the multiple time units included in each time unit subset of the multiple time unit subsets are sequentially in one-to-one correspondence.

### Embodiment 8

Embodiment 8 illustrates a schematic diagram of relations among first information, a second time length, a first time length and a second time unit set according to one embodiment of the present application, as shown in FIG. 8.

In Embodiment 8, the first information in the present application is used for indicating the second time length in the present application, the second time length being different from the first time length in the present application; the second time length is used to determine at least the latter one of the first time length and the second time unit set in the present application.

In one embodiment, the second time length is equal to a non-positive integer in milliseconds (ms).

In one embodiment, the second time length is smaller than the first time length.

In one embodiment, the second time length is larger than the first time length.

In one embodiment, the first information is used to explicitly indicate the second time length.

In one embodiment, the first information is used to implicitly indicate the second time length.

In one embodiment, the first information is used to indicate the second time length from a second candidate time length set, the second candidate time length set being default or configurable.

In one embodiment, the first time length is a time length in a first candidate time length set, the first candidate time length set not comprising the second time length.

In one embodiment, the second time length is used to determine the first time length.

In one embodiment, the first time length is a function of the second time length.

In one embodiment, the first time length is equal to a largest positive integer milliseconds (ms) no greater than the second time length.

In one embodiment, the first time length is equal to a largest time length no greater than the second time length in a first candidate time length set, the first candidate time length set comprising at least 10 ms, 20 ms, 32 ms, 40 ms, 64 ms, 80 ms, 128 ms, 160 ms, 320 ms and 640 ms.

In one embodiment, the first time length is equal to a smallest positive integer milliseconds (ms) no less than the second time length.

In one embodiment, the second time length is used to determine which time units in the first time unit set belong to the second time unit set.

In one embodiment, an index of a K1-th time unit in the second time unit set=f1 (the second time length, K1); where K1 is any positive integer no greater than a total number of time units included in the second time unit set, and f1 (the second time length, K1) denotes a functional relationship with the second time length and the K1 as the independent variables.

In one embodiment, the second time length is used to determine a first reference time set, the first reference time set comprising multiple reference times; the first reference time set is used to determine which time units in the first time unit set belong to the second time unit set.

In one embodiment, the second time length is used to determine a first reference time set, the first reference time set comprising multiple reference times; time-domain relations between reference times in the first reference time set and time units in the first time unit set are used to determine which time units in the first time unit set belong to the second time unit set.

In one embodiment, a given reference time is any reference time in the first reference time set, and the second time unit set comprises a time unit in the first time unit set that is closest to the given reference time.

In one embodiment, a given reference time is any reference time in the first reference time set, and the second time unit set comprises a time unit in the first time unit set of which a start time is closest to the given reference time.

In one embodiment, a given reference time is any reference time in the first reference time set, and the second time unit set comprises a time unit in the first time unit set of which an end time is closest to the given reference time.

In one embodiment, a given reference time is any reference time in the first reference time set, and the second time unit set comprises a time unit in the first time unit set of which a center time is closest to the given reference time; for any time unit in the first time unit set, a duration from the start time to the center time is equal to that from the center time to the end time.

In one embodiment, a given reference time is any reference time in the first reference time set, and the second time unit set comprises a time unit in the first time unit set of which a start time is no earlier than the given reference time and which is closest to the given reference time.

In one embodiment, a given reference time is any reference time in the first reference time set, and the second time unit set comprises a time unit in the first time unit set of which an end time is no earlier than the given reference time and which is closest to the given reference time.

In one embodiment, a given reference time is any reference time in the first reference time set, and the second time unit set comprises a time unit in the first time unit set of which an end time is no later than the given reference time and which is closest to the given reference time.

In one embodiment, a given reference time is any reference time in the first reference time set, and the second time unit set comprises a time unit in the first time unit set of which a start time is no later than the given reference time and which is closest to the given reference time.

In one embodiment, the second time length is used to determine a first reference time set, the first reference time set comprising multiple reference times; a first time unit set group comprises multiple time unit sets, the first time unit set being one of the multiple time unit sets; the first reference time set is used to determine a third time unit set from the first time unit set group; the second time unit set is formed by time units in the third time unit set that belong to the first time unit set.

In one subembodiment, a given reference time is any reference time in the first reference time set, and the third time unit set comprises a time unit among all time units comprised by the first time unit set group of which a start time is closest to the given reference time.

In one subembodiment, a given reference time is any reference time in the first reference time set, and the third time unit set comprises a time unit among all time units comprised by the first time unit set group of which an end time is closest to the given reference time.

In one subembodiment, a given reference time is any reference time in the first reference time set, and the third time unit set comprises a time unit among all time units comprised by the first time unit set group of which a center time is closest to the given reference time; for any time unit in the first time unit set group, a duration from the start time to the center time is equal to that from the center time to the end time.

In one subembodiment, a given reference time is any reference time in the first reference time set, and the third time unit set comprises a time unit among all time units comprised by the first time unit set group of which a start time is no earlier than the given reference time and which is closest to the given reference time.

In one subembodiment, a given reference time is any reference time in the first reference time set, and the third time unit set comprises a time unit among all time units comprised by the first time unit set group of which an end time is no earlier than the given reference time and which is closest to the given reference time.

In one subembodiment, a given reference time is any reference time in the first reference time set, and the third time unit set comprises a time unit among all time units comprised by the first time unit set group of which an end time is no later than the given reference time and which is closest to the given reference time.

In one subembodiment, a given reference time is any reference time in the first reference time set, and the third time unit set comprises a time unit among all time units comprised by the first time unit set group of which a start time is no later than the given reference time and which is closest to the given reference time.

In one embodiment, any two time unit sets in the first time unit set group are mutually non-intersected.

In one embodiment, each time unit set in the first time unit set group comprises multiple time units.

In one embodiment, each time unit set in the first time unit set group comprises multiple time units sequentially arranged at equal intervals.

In one embodiment, multiple time unit sets in the first time unit set group are respectively reserved for downlink assignments for different semi-persistent schedulings.

In one embodiment, the second time length is used to indicate the first reference time set.

In one embodiment, any reference time in the first reference time set is equal to a first offset value plus a non-negative integral multiple of the second time length, where the first offset value is a value indicated by a DCI or configured by higher-layer signaling.

In one embodiment, an earliest reference time in the first reference time set is a time determined based on indication by a DCI or higher-layer signaling.

In one embodiment, a time interval between any two adjacent reference times in the first reference time set is equal to the second time length.

### Embodiment 9

Embodiment 9 illustrates a schematic diagram illustrating a second time length and a first time length according to one embodiment of the present application, as shown in FIG. 9.

In Embodiment 9, the first time length in the present application is equal to a positive integer in millisecond(s) (ms), while the second time length in the present application is equal to a non-positive integer in ms.

In one embodiment, the second time length is equal to 1/30s.

In one embodiment, the second time length is equal to 1/60s.

In one embodiment, the second time length is equal to 1/120s.

In one embodiment, the second time length is equal to 0.9765625 ms.

In one embodiment, the positive integer in millisecond(s) (ms) is a positive integral multiple of 1 ms.

In one embodiment, the non-positive integer in millisecond(s) (ms) is not a positive integral multiple of 1 ms.

In one embodiment, the second time length is not a positive integral multiple of a duration of one symbol.

### Embodiment 10

Embodiment 10 illustrates a schematic diagram illustrating an index of a time unit in a first time unit set according to one embodiment of the present application, as shown in FIG. 10.

In Embodiment 10, the first signaling in the present application is used to determine the index of the first starting time unit in the present application; an index of a time unit in the first time unit set in the present application is equal to a result yielded by a sum of the index of the first starting time unit and a first value modulo a second value, where the first value is related to the first time length in the present application, and the second value is linear with a number of consecutive slots per frame.

In one embodiment, the first starting time unit is a starting time unit in the first time unit set.

In one embodiment, the first starting time unit is a starting time unit in the second time unit set.

In one embodiment, the first starting time unit is before a starting time unit in the first time unit set, where a time interval between a start time of the first starting time unit and a start time of the starting time unit in the first time unit set is equal to the first time length.

In one embodiment, the first starting time unit is before a starting time unit in the second time unit set, where a time interval between a start time of the first starting time unit and a start time of the starting time unit in the second time unit set is equal to the first time length.

In one embodiment, the first starting time unit is before a starting time unit in the first time unit set, where a time interval between a start time of the first starting time unit and a start time of the starting time unit in the first time unit set is equal to a positive integral multiple of the first time length.

In one embodiment, the first starting time unit is before a starting time unit in the second time unit set, where a time interval between a start time of the first starting time unit and a start time of the starting time unit in the second time unit set is equal to a positive integral multiple of the first time length.

In one embodiment, the first signaling is used to indicate the index of the first starting time unit.

In one embodiment, the first signaling is used to explicitly indicate the index of the first starting time unit.

In one embodiment, the first signaling is used to implicitly indicate the index of the first starting time unit.

In one embodiment, the first starting time unit is: a time unit to which a PDSCH that initializes (or re-initializes) a configured downlink assignment belongs in time domain when the first signaling activates the first semi-persistent scheduling.

In one embodiment, the index of the first starting time unit is: an index of a time unit to which a PDSCH that initializes (or re-initializes) a configured downlink assignment belongs in time domain when the first signaling activates the first semi-persistent scheduling.

In one embodiment, the index of the first starting time unit is equal to: a number of consecutive slots per frame times a first frame number plus a first slot number; the first frame number and the first slot number are respectively a system frame number (SFN) of a frame and an intra-frame slot number of a slot to which a PDSCH that initializes (or re-initializes) a configured downlink assignment belongs in time domain when the first signaling activates the first semi-persistent scheduling.

In one embodiment, the first time length is used to determine the first value.

In one embodiment, the first value is equal to a positive integral multiple of the first time length.

In one embodiment, the first value is equal to a positive integral multiple of a third value, the third value being equal to the first time length multiplied by the number of consecutive slots per frame divided by 10.

In one embodiment, the second value is equal to a positive integral multiple of the number of consecutive slots per frame.

In one embodiment, the second value is equal to 1024 times the number of consecutive slots per frame.

In one embodiment, a time interval between a start time of the first starting time unit and a start time of a time unit in the first time unit set is equal to N times the first time length, N being a positive integer; an index of the time unit in the first time unit set is equal to a result yielded by a sum of an index of the first starting time unit and a first value modulo a second value, where the first value is equal to N times the first time length times the number of consecutive slots per frame divided by 10, and the second value is equal to 1024 times the number of consecutive slots per frame.

In one embodiment, a number of consecutive time units between the first starting time unit and a time unit in the first time unit set is equal to N−1, N being a positive integer; an index of the time unit in the first time unit set is equal to a result yielded by a sum of an index of the first starting time unit and a first value modulo a second value, where the first value is equal to N times the first time length times the number of consecutive slots per frame divided by 10, and the second value is equal to 1024 times the number of consecutive slots per frame.

In one embodiment, the first time unit set is formed by T1 time units, where a time interval between a start time of the first starting time unit and a start time of a starting time unit in the first time unit set is equal to T2 times the first time length; T1 is equal to one of 1, 2 . . . , and T3, and T2 is equal to one of 1, 2 . . . and T3, and T3 is equal to 1024 times the number of consecutive slots per frame.

### Embodiment 11

Embodiment 11 illustrates a schematic diagram of relation(s) between at least one of {a Modulation and Coding Scheme (MCS) used, a number of frequency-domain resources occupied, a number of time-domain resources occupied} by the target downlink assignment corresponding to a given time unit and a time-domain position of the given time unit according to one embodiment of the present application, as shown in FIG. 11.

In Embodiment 11, a given time unit is one time unit in the second time unit set in the present application, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

In one embodiment, the given time unit is any time unit in the second time unit set.

In one embodiment, a time-domain position of the given time unit is used to determine at least one of {a Modulation and Coding Scheme (MCS) used, a number of frequency-domain resources occupied, a number of time-domain resources occupied} by the target downlink assignment corresponding to the given time unit.

In one embodiment, an MCS used by a target downlink assignment corresponding to the given time unit is associated with an index of the given time unit based on a mapping relationship between an MCS which is default or configured by higher-layer signaling and time unit indexes.

In one embodiment, a number of frequency-domain resources occupied by a target downlink assignment corresponding to the given time unit is associated with an index of the given time unit based on a mapping relationship between a number of frequency-domain resources which is default or configured by higher-layer signaling and time unit indexes.

In one embodiment, a number of time-domain resources occupied by a target downlink assignment corresponding to the given time unit is associated with an index of the given time unit based on a mapping relationship between a number of time-domain resources which is default or configured by higher-layer signaling and time unit indexes.

In one embodiment, a time-domain relation between the given time unit and a reference time corresponding to the given time unit in the first reference time set in the present application is used to determine a Modulation and coding scheme (MCS) used by the target downlink assignment corresponding to the given time unit.

In one embodiment, when a time interval between a start time (or an end time) of the given time unit and a reference time corresponding to the given time unit in the first reference time set in the present application is greater than a first threshold, an MCS used by the target downlink assignment corresponding to the given time unit is a first MCS; when a time interval between a start time (or an end time) of the given time unit and a reference time corresponding to the given time unit in the first reference time set in the present application is no greater than the first threshold, an MCS used by the target downlink assignment corresponding to the given time unit is a second MCS; the first threshold is a default or configurable value, and the first MCS is different from the second MCS.

In one embodiment, when a time interval between a start time (or an end time) of the given time unit and a reference time corresponding to the given time unit in the first reference time set in the present application is less than a first threshold, an MCS used by the target downlink assignment corresponding to the given time unit is a first MCS; when a time interval between a start time (or an end time) of the given time unit and a reference time corresponding to the given time unit in the first reference time set in the present application is no less than the first threshold, an MCS used by the target downlink assignment corresponding to the given time unit is a second MCS; the first threshold is a default or configurable value, and the first MCS is different from the second MCS.

In one embodiment, the first MCS is default, or, the first MCS is indicated by a DCI or higher-layer signaling; the second MCS is default, or, the second MCS is indicated by a DCI or higher-layer signaling.

In one embodiment, a time-domain relation between the given time unit and a reference time corresponding to the given time unit in the first reference time set in the present application is used to determine a number of time-domain/frequency-domain resources occupied by the target downlink assignment corresponding to the time unit.

In one embodiment, when a time interval between a start time (or an end time) of the given time unit and a reference time corresponding to the given time unit in the first reference time set in the present application is greater than a first threshold, a number of frequency-domain resources occupied by the target downlink assignment corresponding to the given time unit is a first number; when a time interval between a start time (or an end time) of the given time unit and a reference time corresponding to the given time unit in the first reference time set in the present application is no greater than the first threshold, a number of frequency-domain resources occupied by the target downlink assignment corresponding to the given time unit is a second number; the first threshold is a default or configurable value, and the first number is different from the second number.

In one embodiment, when a time interval between a start time (or an end time) of the given time unit and a reference time corresponding to the given time unit in the first reference time set in the present application is less than a first threshold, a number of frequency-domain resources occupied by the target downlink assignment corresponding to the given time unit is a first number; when a time interval between a start time (or an end time) of the given time unit and a reference time corresponding to the given time unit in the first reference time set in the present application is no less than the first threshold, a number of frequency-domain resources occupied by the target downlink assignment corresponding to the given time unit is a second number; the first threshold is a default or configurable value, and the first number is different from the second number.

In one embodiment, when a time interval between a start time (or an end time) of the given time unit and a reference time corresponding to the given time unit in the first reference time set in the present application is greater than a first threshold, a number of time-domain resources occupied by the target downlink assignment corresponding to the given time unit is a first number; when a time interval between a start time (or an end time) of the given time unit and a reference time corresponding to the given time unit in the first reference time set in the present application is no greater than the first threshold, a number of time-domain resources occupied by the target downlink assignment corresponding to the given time unit is a second number; the first threshold is a default or configurable value, and the first number is different from the second number.

In one embodiment, when a time interval between a start time (or an end time) of the given time unit and a reference time corresponding to the given time unit in the first reference time set in the present application is less than a first threshold, a number of time-domain resources occupied by the target downlink assignment corresponding to the given time unit is a first number; when a time interval between a start time (or an end time) of the given time unit and a reference time corresponding to the given time unit in the first reference time set in the present application is no less than the first threshold, a number of time-domain resources occupied by the target downlink assignment corresponding to the given time unit is a second number; the first threshold is a default or configurable value, and the first number is different from the second number.

In one embodiment, the first number is default, or, the first number is indicated by a DCI or higher-layer signaling; the second number is default, or, the second number is indicated by a DCI or higher-layer signaling.

### Embodiment 12

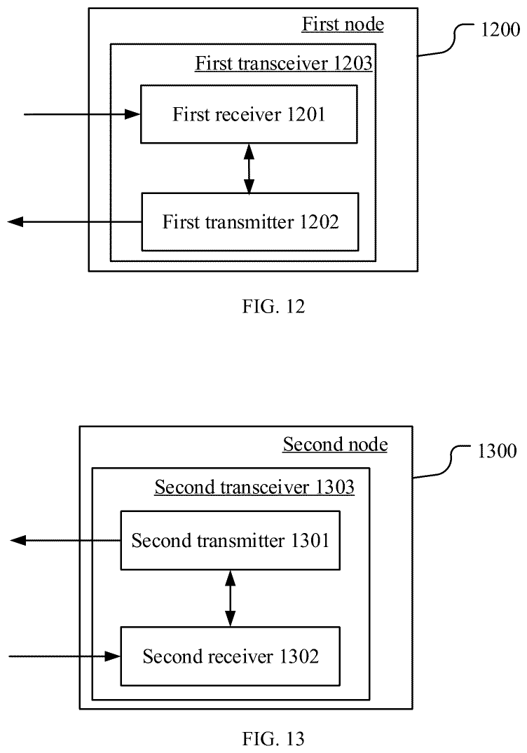

Embodiment 12 illustrates a structure block diagram a processing device in a first node, as shown in FIG. 12. In FIG. 12, the first node's processing device 1200 comprises a first transceiver 1203, the first transceiver 1203 comprising a first receiver 1201 and a first transmitter 1202.

In one embodiment, the first node 1200 is a UE.

In one embodiment, the first node 1200 is a relay node.

In one embodiment, the first node 1200 is vehicle-mounted communication equipment.

In one embodiment, the first node 1200 is a UE supporting V2X communications.

In one embodiment, the first node 1200 is a relay node supporting V2X communications.

In one embodiment, the first receiver 1201 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1202 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first two of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first two of the antenna 452, the transmitter 454, the multi-antenna transmitting processor 457, the transmitting processor 468, the controller/processor 459, the memory 460 and the data source 467 in FIG. 4 of the present application.

In Embodiment 12, the first receiver 1201 receives first information, or the first transmitter 1202 transmits first information; the first receiver 1201 receives a first signaling, and performs reception of a target downlink assignment in each time unit in a second time unit set; herein, the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one embodiment, there are three time units in the second time unit set: the three time units are adjacent in the second time unit set, and, a time interval between start times of the first two time units among the three time units is unequal to a time interval between start times of the last two time units among the three time units.

In one embodiment, the first information is used for configuring a first bitmap, the first bitmap comprising multiple bits, the first bitmap being used to determine the second time unit set from the first time unit set.

In one embodiment, the first information is used for indicating a second time length, the second time length being different from the first time length; the second time length is used to determine at least a latter one of the first time length and the second time unit set.

In one embodiment, the first time length is equal to a positive integer in millisecond(s) (ms), while the second time length is equal to a non-positive integer in ms.

In one embodiment, the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

In one embodiment, a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

### Embodiment 13

Embodiment 13 illustrates a structure block diagram of a processing device in a second node, as shown in FIG. 13. In FIG. 13, a second node's processing device 1300 comprises a second transceiver 1303, the second transceiver 1303 being comprised of a second transmitter 1301 and a second receiver 1302.

In one embodiment, the second node 1300 is a UE.

In one embodiment, the second node 1300 is a base station.

In one embodiment, the second node 1300 is a relay node.

In one embodiment, the second node 1300 is vehicle-mounted communication equipment.

In one embodiment, the second node 1300 is UE supporting V2X communications.

In one embodiment, the second transmitter 1301 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1302 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first two of the antenna 420, the receiver 418, the multi-antenna receiving processor 472, the receiving processor 470, the controller/processor 475 and the memory 476 in FIG. 4 of the present application.

In Embodiment 13, the second transmitter 1301 transmits first information, or the second receiver 1302 receives first information; the second transmitter 1301 transmits a first signaling, and performs transmission in a target downlink assignment corresponding to at least one time unit in a second time unit set; herein, the first signaling is used for activating a first semi-persistent scheduling (SPS), each time unit in the second time unit set corresponds to a target downlink assignment, and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

In one embodiment, there are three time units in the second time unit set: the three time units are adjacent in the second time unit set, and, a time interval between start times of the first two time units among the three time units is unequal to a time interval between start times of the last two time units among the three time units.

In one embodiment, the first information is used for configuring a first bitmap, the first bitmap comprising multiple bits, the first bitmap being used to determine the second time unit set from the first time unit set.

In one embodiment, the first information is used for indicating a second time length, the second time length being different from the first time length; the second time length is used to determine at least a latter one of the first time length and the second time unit set.

In one embodiment, the first time length is equal to a positive integer in millisecond(s) (ms), while the second time length is equal to a non-positive integer in ms.

In one embodiment, the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

In one embodiment, a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present application includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first transceiver, receiving first information, or, transmitting first information; and
a first receiver, receiving a first signaling, and performing reception of a target downlink assignment in each time unit in a second time unit set;
wherein the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

2. The first node according to claim 1, characterized in that there are three time units in the second time unit set: the three time units are adjacent in the second time unit set, and, a time interval between start times of the first two time units among the three time units is unequal to a time interval between start times of the last two time units among the three time units.

3. The first node according to claim 1, characterized in that the first information is used for configuring a first bitmap, the first bitmap comprising multiple bits, the first bitmap being used to determine the second time unit set from the first time unit set.

4. The first node according to claim 1, characterized in that the first information is used for indicating a second time length, the second time length being different from the first time length; the second time length is used to determine at least a latter one of the first time length and the second time unit set.

5. The first node according to claim 4, characterized in that the first time length is equal to a positive integer in millisecond(s) (ms), while the second time length is equal to a non-positive integer in ms.

6. The first node according to claim 1, characterized in that the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

7. The first node according to claim 1, characterized in that a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.

8. A second node for wireless communications, characterized in comprising:
a second transceiver, transmitting first information, or, receiving first information; and
a second transmitter, transmitting a first signaling, and performing transmission in a target downlink assignment corresponding to at least one time unit in a second time unit set;
wherein the first signaling is used for activating a first semi-persistent scheduling (SPS), each time unit in the second time unit set corresponds to a target downlink assignment, and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

9. The second node according to claim 8, characterized in that there are three time units in the second time unit set: the three time units are adjacent in the second time unit set, and, a time interval between start times of the first two time units among the three time units is unequal to a time interval between start times of the last two time units among the three time units.

10. The second node according to claim 8, characterized in that the first information is used for configuring a first bitmap, the first bitmap comprising multiple bits, the first bitmap being used to determine the second time unit set from the first time unit set.

11. The second node according to claim 8, characterized in that the first information is used for indicating a second time length, the second time length being different from the first time length; the second time length is used to determine at least a latter one of the first time length and the second time unit set.

12. The second node according to claim 11, characterized in that the first time length is equal to a positive integer in millisecond(s) (ms), while the second time length is equal to a non-positive integer in ms.

13. The second node according to claim 8, characterized in that the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

14. A method in a first node for wireless communications, characterized in comprising:
receiving first information, or, transmitting first information; and
receiving a first signaling, and performing reception of a target downlink assignment in each time unit in a second time unit set;
wherein the first signaling is used for activating a first semi-persistent scheduling (SPS), and the target downlink assignment corresponding to each time unit in the second time unit set is a downlink assignment for the first SPS; the first signaling is used to determine at least one of a first time unit set or the second time unit set, the first time unit set consisting of multiple time units sequentially arranged in time domain; a time interval between start times of any two adjacent time units in the first time unit set is equal to the first time length, the first time length being no smaller than a duration of one slot; the second time unit set is a proper subset of the first time unit set; the first information is used to determine which time units in the first time unit set belong to the second time unit set.

15. The method in the first node according to claim 14, characterized in that there are three time units in the second time unit set: the three time units are adjacent in the second time unit set, and, a time interval between start times of the first two time units among the three time units is unequal to a time interval between start times of the last two time units among the three time units.

16. The method in the first node according to claim 14, characterized in that the first information is used for configuring a first bitmap, the first bitmap comprising multiple bits, the first bitmap being used to determine the second time unit set from the first time unit set.

17. The method in the first node according to claim 14, characterized in that the first information is used for indicating a second time length, the second time length being different from the first time length; the second time length is used to determine at least a latter one of the first time length and the second time unit set.

18. The method in the first node according to claim 17, characterized in that the first time length is equal to a positive integer in millisecond(s) (ms), while the second time length is equal to a non-positive integer in ms.

19. The method in the first node according to claim 14, characterized in that the first signaling is used to determine an index of a first starting time unit; an index of a time unit in the first time unit set is equal to a result yielded by a sum of the index of the first starting time unit and a first value modulo a second value, where the first value is related to the first time length, and the second value is linear with a number of consecutive slots per frame.

20. The method in the first node according to claim 14, characterized in that a given time unit is one time unit in the second time unit set, and at least one of {a Modulation and Coding Scheme (MCS) used, a number of frequency-domain resources occupied, a number of time-domain resources occupied} by the target downlink assignment corresponding to the given time unit is related to a time-domain position of the given time unit.
